(19) United States
(12) Patent Application Publication
(10) Pub. No.: US 2026/0202694 A1
(43) Pub. Date: Jul. 16, 2026

(54) HYBRID PLASMONIC ELECTRO-ABSORPTION MODULATORS

(71) Applicant: GlobalFoundries U.S. Inc., Malta, NY (US)

(72) Inventors: Yusheng Bian, Ballston Lake, NY (US); Steven M. Shank, Jericho, VT (US); Judson R. Holt, Ballston Lake, NY (US)

(21) Appl. No.: 19/018,043

(22) Filed: Jan. 13, 2025

(51) Int. Cl. G02F 1/015

(52) U.S. Cl. CPC G02F 1/0157; G02F 2203/10

(57) ABSTRACT

Structures for an electro-absorption modulator and methods of forming a structure for an electro-absorption modulator. The structure comprises a first metal layer and a second metal layer adjacent to the multiple-layer structure, a waveguide core, and a multiple-layer structure on a portion of the waveguide core. The multiple-layer structure comprises a first plurality of layers and a second plurality of layers that alternate with the first plurality of layers. The first plurality of layers comprise a first material, and the second plurality of layers comprise a second material. The multiple-layer structure is positioned in a lateral direction between the first metal layer and the second metal layer.

### BACKGROUND

The disclosure relates to photonic chips and, more specifically, to structures for an electro-absorption modulator and methods of forming a structure for an electro-absorption modulator.

Photonic chips are used in many applications and systems including, but not limited to, data communication systems, data centers, and data computation systems. A photonic chip includes a photonic integrated circuit comprised of photonic components, such as modulators, polarizers, and couplers, that are used to manipulate light received from a light source, such as a laser or an optical fiber.

An electro-absorption modulator is a type of optical component that may be used to modulate light intensity through the application of an electric field. Some electro-absorption modulators include a quantum well structure that is capable of operating with a high extinction ratio by exploiting the quantum-confined Stark effect to vary the absorption spectrum. However, the coupling efficiency for light with the quantum well structure may be limited by factors such as mode profile mismatch. The limitation on coupling efficiency may restrict the efficiency of operation of the quantum well structure.

Improved structures for an electro-absorption modulator and methods of forming a structure for an electro-absorption modulator are needed.

### SUMMARY

In an embodiment of the invention, a structure for a hybrid plasmonic electro-absorption modulator is provided. The structure comprises a first metal layer and a second metal layer adjacent to the multiple-layer structure, a waveguide core, and a multiple-layer structure on a portion of the waveguide core. The multiple-layer structure comprises a first plurality of layers and a second plurality of layers that alternate with the first plurality of layers. The first plurality of layers comprise a first material, and the second plurality of layers comprise a second material. The multiple-layer structure is positioned in a lateral direction between the first metal layer and the second metal layer.

In an embodiment of the invention, a method of forming a structure for a hybrid plasmonic electro-absorption modulator is provided. The method comprises forming a first metal layer and a second metal layer, forming a waveguide core, and forming a multiple-layer structure on a portion of the waveguide core. The multiple-layer structure comprises a first plurality of layers and a second plurality of layers that alternate with the first plurality of layers. The first plurality of layers comprise a first material, and the second plurality of layers comprise a second material. The multiple-layer structure is positioned in a lateral direction between the first metal layer and the second metal layer.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a top view of a structure at an initial fabrication stage of a processing method in accordance with embodiments of the invention.

FIG. 2 is a cross-sectional view taken generally along line 2-2 in FIG. 1.

FIG. 2A is a cross-sectional view taken generally along line 2A-2A in FIG. 1.

FIG. 3 is a top view of the structure at a fabrication stage of the processing method subsequent to FIG. 1.

FIG. 4 is a cross-sectional view taken generally along line 4-4 in FIG. 3.

FIG. 4A is a cross-sectional view taken generally along line 4A-4A in FIG. 3.

FIG. 5 is a top view of the structure at a fabrication stage of the processing method subsequent to FIG. 3.

FIG. 6 is a cross-sectional view taken generally along line 6-6 in FIG. 5.

FIG. 6A is a cross-sectional view taken generally along line 6A-6A in FIG. 5.

FIGS. 7, 7A are cross-sectional views of the structure at a fabrication stage of the processing method subsequent to FIGS. 5, 6, 6A.

FIGS. 8, 8A are cross-sectional views of a structure in accordance with alternative embodiments of the invention.

FIG. 9 is a cross-sectional view of a structure in accordance with alternative embodiments of the invention.

FIG. 10 is a top view of a structure in accordance with alternative embodiments of the invention.

### DETAILED DESCRIPTION

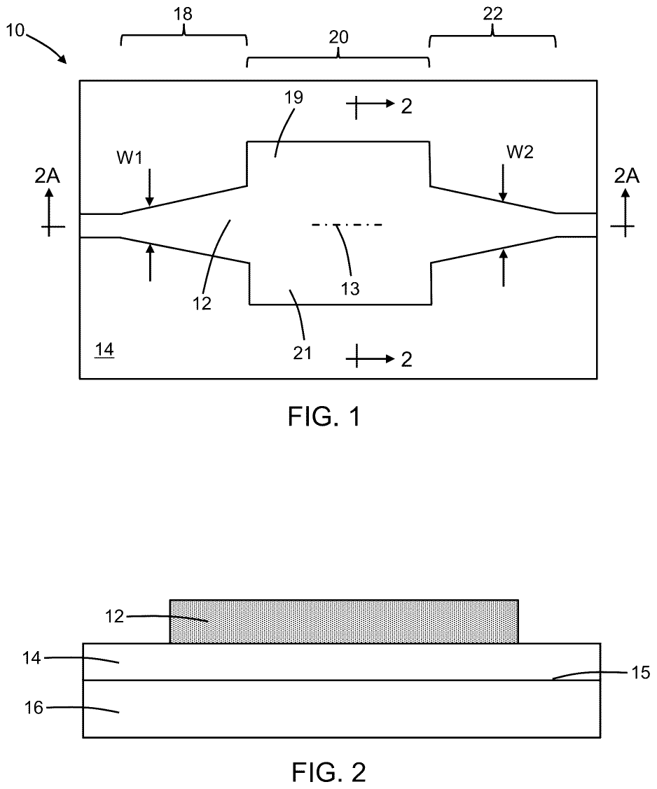

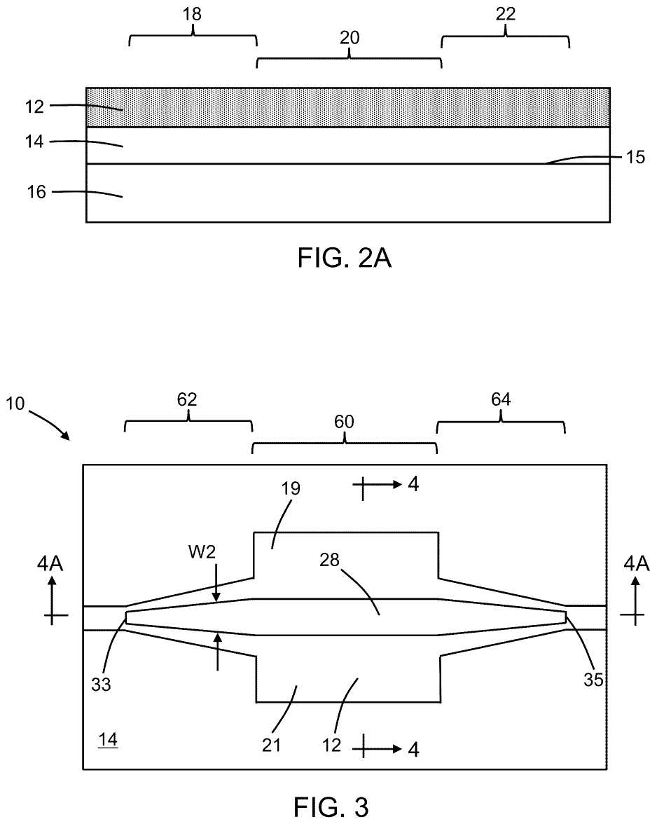

With reference to FIGS. 1, 2, 2A and in accordance with embodiments of the invention, a structure 10 for a hybrid plasmonic electro-absorption modulator includes a waveguide core 12 that is positioned on, and overlies, a dielectric layer 14 and a substrate 16. In an embodiment, the dielectric layer 14 may be comprised of a dielectric material, such as silicon dioxide, and the substrate 16 may be comprised of a semiconductor material, such as single-crystal silicon. In an embodiment, the dielectric layer 14 may be a buried oxide layer of a silicon-on-insulator substrate, the dielectric layer 14 may adjoin the substrate 16 along an interface 15 contained in a horizontal plane, and the waveguide core 12 and the dielectric layer 14 may have respective top surfaces that are each contained in a horizontal plane that is parallel to the horizontal plane of the interface 15. In an alternative embodiment, one or more additional dielectric layers comprised of a dielectric material, such as silicon dioxide, may be arranged between the dielectric layer 14 and the waveguide core 12.

The waveguide core 12 may include a tapered section 18, a section 20, and a tapered section 22 that are lengthwise aligned along a longitudinal axis 13 of the waveguide core 12 with the section 20 longitudinally arranged between the tapered section 18 and the tapered section 22. The tapered section 18 and the tapered section 22 of the waveguide core 12 may be connected to other optical components of a photonic integrated circuit on a photonic chip.

The tapered section 18 of the waveguide core 12 may have a width dimension W1 and the tapered section 22 of the waveguide core 12 may have a width dimension W2. In an embodiment, the width dimension W1 of the tapered section 18 may increase with decreasing distance from the section 20, and the width dimension W2 of the tapered section 22 may also increase with decreasing distance from the section 20. In an embodiment, the width dimensions W1, W2 may linearly increase with decreasing distance from the section 20. In an alternative embodiment, the width dimensions W1, W2 may increase based on a non-linear function, such as a quadratic function, a cubic function, a parabolic function, a sine function, a cosine function, a Bezier function, or an exponential function. In an embodiment, the tapered sections 18, 22 may have a uniform taper angle. In an alternative embodiment, the tapered sections 18, 22 may taper in multiple stages each having a different taper angle.

The section 20 has an edge portion 19 and an edge portion 21 that project outwardly from respective portions of the section 20 that are adjoined to the tapered sections 18, 22. In an embodiment, the section 20 may be non-tapered and may have a constant width dimension that is greater than either the width dimension W1 of the tapered section 18 or the width dimension W2 of the tapered section 22.

In an embodiment, the waveguide core 12 may be comprised of a material having a refractive index that is greater than the refractive index of silicon dioxide. In an embodiment, the waveguide core 12 may be comprised of a semiconductor material, such as single-crystal silicon. In an alternative embodiment, the waveguide core 12 may be comprised of a dielectric material, such as silicon nitride, silicon oxynitride, or aluminum nitride. In alternative embodiments, other materials, such as a polymer or a III-V compound semiconductor, may be used to form the waveguide core 12.

In an embodiment, the waveguide core 12 may be formed by patterning a layer of material with lithography and etching processes. In an embodiment, the waveguide core 12 may be formed by patterning the semiconductor material (e.g., single-crystal silicon) of a device layer of a silicon-on-insulator substrate. In an embodiment, the waveguide core 12 may be formed by patterning a deposited layer of its constituent material (e.g., silicon nitride). In an alternative embodiment, a slab layer may be connected to a lower portion of the waveguide core 12. The slab layer may be formed when the waveguide core 12 is patterned, and the slab layer, which is positioned on the dielectric layer 14, may have a thickness that is less than the thickness of the waveguide core 12.

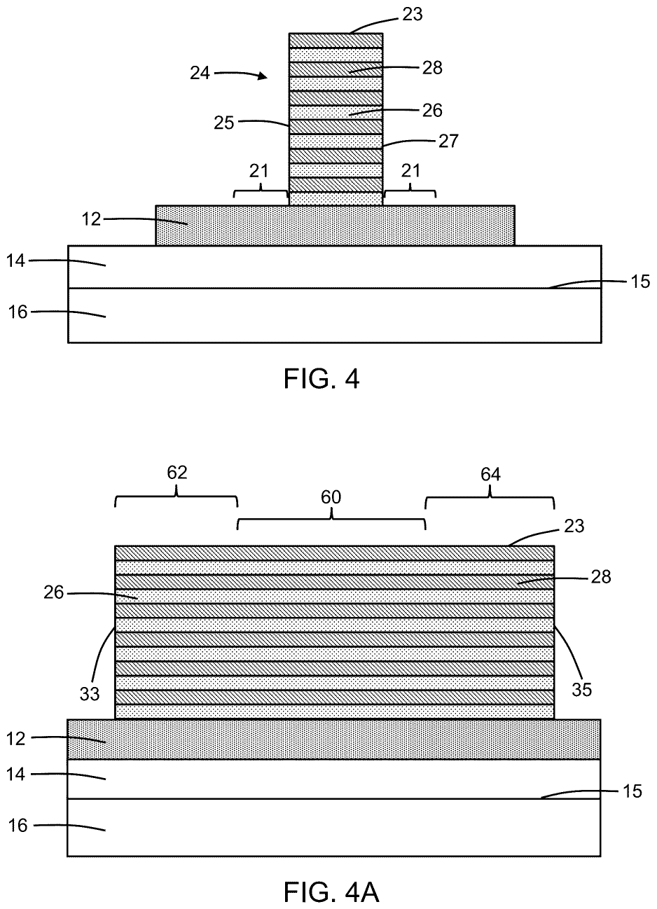

With reference to FIGS. 3, 4, 4A in which like reference numerals refer to like features in FIGS. 1, 2, 2A and at a subsequent fabrication stage, a quantum well structure 24 that is formed as a multiple-layer structure on a portion of the waveguide core 12 and, more specifically, on a portion of the section 20 of the waveguide core 12. The portion of the section 20 of the waveguide core 12 on which the quantum well structure 24 is laterally arranged between the edge portion 19 of the section 20 of the waveguide core 12 and the edge portion 21 of the section 20 of the waveguide core 12.

The quantum well structure 24 may include layers 26 and layers 28 that alternate with the layers 26 in the multiple-layer structure. Each of the layers 26, 28 may have a thickness of a few nanometers. In an embodiment, the layers 26 may be comprised of a different material than the layers 28. In an embodiment, the layers 26 and the layers 28 may be comprised of materials with different compositions that can be tailored to, for example, select the wavelength of emitted light. In an embodiment, the layers 26 may be comprised of silicon-germanium, and the layers 28 may be comprised of silicon-germanium with a germanium content that is greater than the germanium content of the layers 26. In an embodiment, the layers 26 may be comprised of silicon-germanium with a germanium content of about 5 atomic percent, and the layers 28 may be comprised of silicon-germanium with a germanium content of about 30 atomic percent. The bandgap of silicon-germanium varies with the germanium content with a higher germanium content leading to a smaller bandgap. In an alternative embodiment, the layers 26 may be comprised of a III-V compound semiconductor (e.g., gallium arsenide), and the layers 28 may be comprised of a different III-V compound semiconductor (e.g., aluminum gallium arsenide). The layers 26, 28 of a lower portion of the quantum well structure 24 may be tailored in composition and/or thickness to provide a buffer layer that accommodates lattice mismatch and provides strain relief.

The quantum well structure 24 has a top surface 23, a bottom surface opposite from the top surface 23 and in contact with a portion of the waveguide core 12, a sidewall 25, and a sidewall 27 opposite from the sidewall 25. In an embodiment, the sidewalls 25, 27 may extend upwardly from the waveguide core 12. In an alternative embodiment, the sidewalls 25, 27 may extend upwardly from the waveguide core 12 with an inward inclination. The layers 26, 28 of the quantum well structure 24 alternate with increasing distance from the top surface 23, which may be arranged in a plane that is parallel to the horizontal plane of the interface between the dielectric layer 14 and the substrate 16. The alternating placement of the layers 26 and the layers 28 produces an alternation in the materials that form the multiple-layer structure embodied in the quantum well structure 24.

The quantum well structure 24 includes a section 62, a section 64, and a section 60 that is longitudinally arranged between the section 62 and the section 64. In an embodiment, the section 62 and the section 64 may terminate the quantum well structure 24 at opposite ends 33, 35, the width dimension of the section 62 may increase with increasing distance from the end 33, and the width dimension of the section 64 may increase with increasing distance from the end 35. In an embodiment, the section 60 of the quantum well structure 24 may be non-tapered.

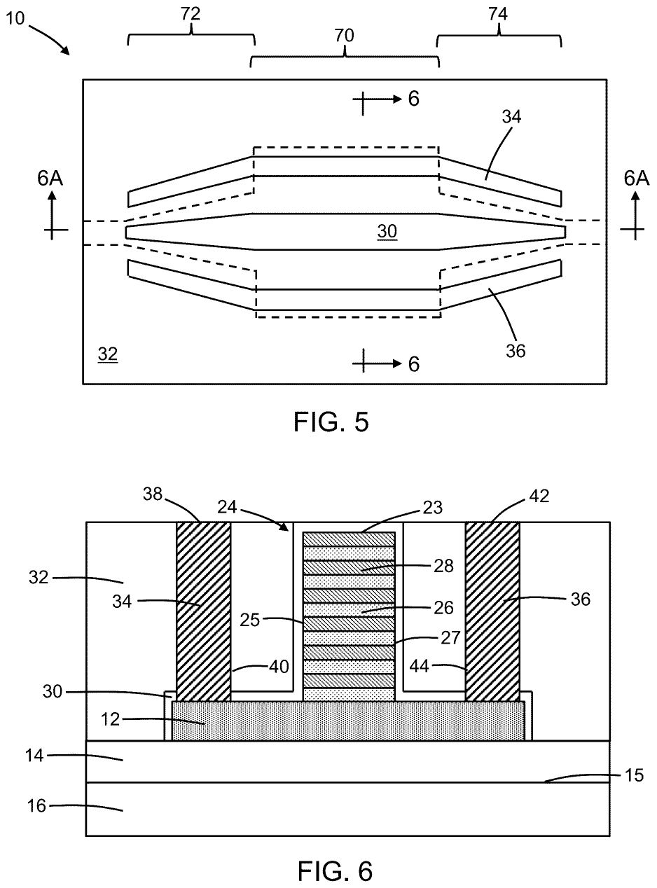

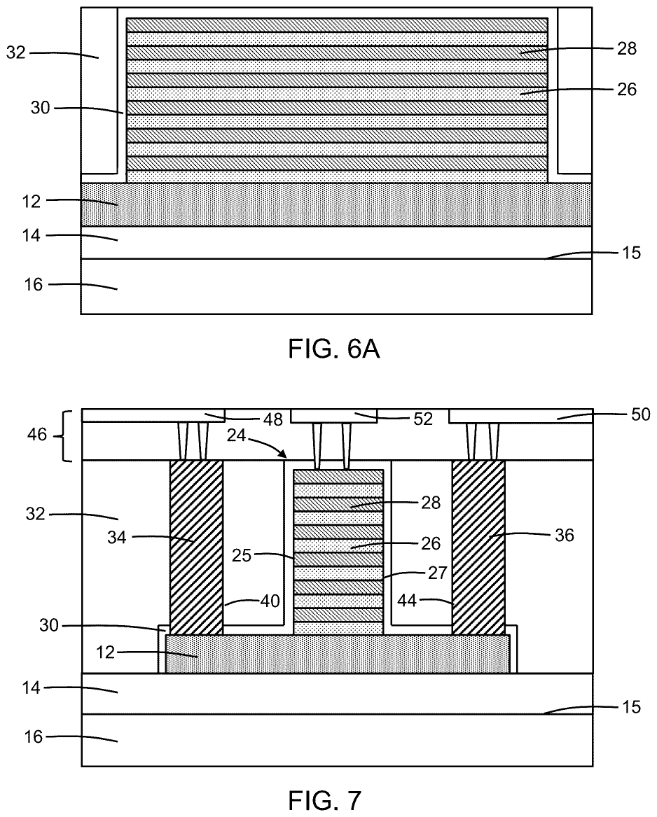

With reference to FIGS. 5, 6, 6A in which like reference numerals refer to like features in FIGS. 3, 4, 4A and at a subsequent fabrication stage, a dielectric layer 30 and a dielectric layer 32 are formed over the waveguide core 12 and quantum well structure 24. The dielectric layer 30 may be comprised of a dielectric material, such as silicon nitride, that is conformally deposited as a coating over the underlying topography. The dielectric layer 32 may be comprised of a dielectric material, such as silicon dioxide, having a lower refractive index than the materials constituting the waveguide core 12 and the quantum well structure 24. The dielectric layer 32 may be deposited and planarized to be substantially coplanar with the portion of the dielectric layer 30 on the top surface of the quantum well structure 24.

A metal layer 34 and a metal layer 36 may be formed in the dielectric layers 30, 32. The metal layers 34, 36 may be positioned in respective openings that are patterned in the dielectric layers 30, 32 by lithography and etching processes. The quantum well structure 24 is laterally positioned between the metal layer 34 and the metal layer 36. The metal layer 34 is positioned with a lateral offset from the quantum well structure 24 and the metal layer 36 is also positioned with a lateral offset from the quantum well structure 24. In an embodiment, the metal layers 34, 36 may be comprised of a metal, such as copper or aluminum, that is employed in back-end-of-line processing. In an alternative embodiment, the metal layers 34, 36 may be comprised of a noble metal, such as gold or silver.

The metal layer 34 has a top surface 38, a bottom surface that is opposite from the top surface 38, and a sidewall 40 adjacent to the sidewall 25 of the quantum well structure 24. In an embodiment, the top surface 38 of the metal layer 34 may be substantially coplanar with the top surface 23 of the quantum well structure 24. The metal layer 34 is laterally spaced from the quantum well structure 24 such that a portion of the dielectric layer 30 and a portion of the dielectric layer 32 are positioned between the sidewall 40 of the metal layer 34 and the sidewall 25 of the quantum well structure 24.

The metal layer 36 has a top surface 42, a bottom surface that is opposite from the top surface 42, and a sidewall 44 adjacent to the sidewall 27 of the quantum well structure 24. In an embodiment, the top surface 42 of the metal layer 36 may be substantially coplanar with the top surface 23 of the quantum well structure 24. The metal layer 36 is laterally spaced from the quantum well structure 24 such that a portion of the dielectric layer 30 and a portion of the dielectric layer 32 are positioned between the sidewall 44 of the metal layer 36 and the sidewall 27 of the quantum well structure 24.

Each of the metal layers 34, 36 includes a section 70 that is positioned adjacent to the section 60 of the quantum well structure 24 and that may directly contact one of the edge portions 19, 21 of the section 20 of the waveguide core 12. The metal layers 34, 36 also include sections 72 that are positioned adjacent to the section 62 of the quantum well structure 24 and that are offset from the edge portions 19, 21 of the section 20 of the waveguide core 12. Each section 72 is angled relative to the adjoining section 70 in a direction that may match the tapering of the section 62 of the quantum well structure 24. The metal layers 34, 36 also include sections 74 that are positioned adjacent to the section 64 of the quantum well structure 24 and that are offset from the edge portions 19, 21 of the section 20 of the waveguide core 12. Each section 74 is angled relative to the adjoining section 70 in a direction that may match the tapering of the section 64 of the quantum well structure 24.

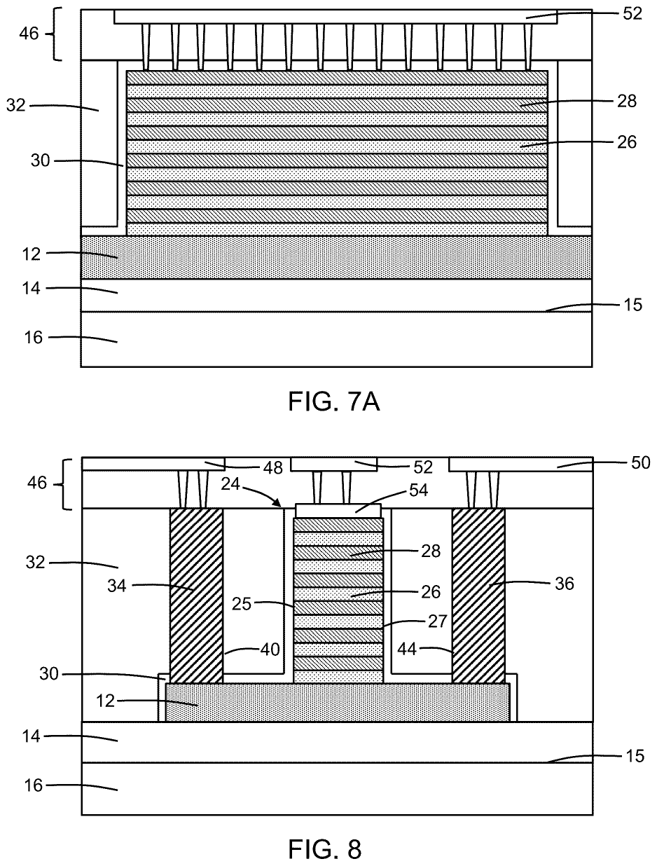

With reference to FIGS. 7, 7A in which like reference numerals refer to like features in FIGS. 5, 6, 6A and at a subsequent fabrication stage, a back-end-of-line stack 46 may be formed over the metal layers 34, 36 and the quantum well structure 24. The back-end-of-line stack 46 may include stacked dielectric layers that are each comprised of a dielectric material, such as silicon dioxide, silicon nitride, tetraethylorthosilicate silicon dioxide, or fluorinated-tetraethylorthosilicate silicon dioxide. The back-end-of-line stack 46 may also include electrical connections 48, 50 in the form of interconnects that are respective coupled by contacts to the metal layers 34, 36 and an electrical connection 52 in the form of an interconnect that is coupled by contacts to the quantum well structure 24 for energizing the quantum well structure 24.

The hybrid plasmonic electro-absorption modulator embodied in the structure 10, which may be deployed in a photonic integrated circuit on a photonic chip, includes the quantum well structure 24 and the metal layers 34, 36. The metal layer 34 and the metal layer 36 provide respective electrodes that are located adjacent to the quantum well structure 24 and that may be used to apply an electric field across the quantum well structure 24. The electro-absorption modulator embodied in the structure 10 enables voltage-dependent absorption of propagating light in the waveguide core 12 that converts a modulated electrical signal to a modulated optical signal. Through a plasmonic effect, the metal layers 34, 36 also assist with the confinement of the propagating light proximate to the quantum well structure 24 by pushing the mode laterally toward the quantum well structure 24 and thereby function to enhance the modulation efficiency.

In alternative embodiments, the electro-absorption modulator may be replaced by a different type of active optical component structured with multiple-layers, such as a detector or a laser.

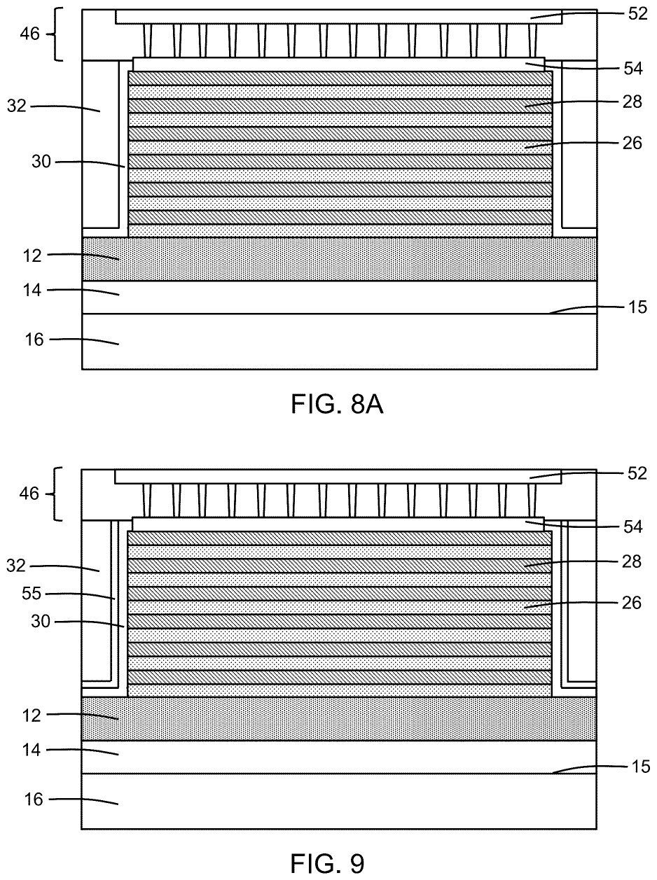

With reference to FIGS. 8, 8A and in accordance with alternative embodiments, a metal layer 54 may be added that is arranged to overlie and overlap with the quantum well structure 24. In an embodiment, the metal layer 54 may directly contact the top surface 23 of the quantum well structure 24. The metal layer 54 may be laterally positioned between the metal layer 34 and the metal layer 36, and the metal layer 54 may be disconnected and spaced from the metal layers 34, 36. The electrical connection 52 may be coupled by contacts to the metal layer 54 instead of being coupled to the top surface 23 of the quantum well structure 24. The metal layer 54 may assist the metal layer 34 and the metal layer 36 with confining propagating light adjacent to the quantum well structure 24.

With reference to FIG. 9 and in accordance with alternative embodiments, the dielectric layer 30 may be coated with a layer 55 before the dielectric layer 32 is formed. The layer 55 may be comprised of a different material than either the dielectric layer 30 or the dielectric layer 32. In embodiments, the layer 55 may be comprised of tantalum nitride, titanium nitride, cobalt, nickel, or silicon carbide, and the layer 55 may function as a diffusion barrier or adhesion layer.

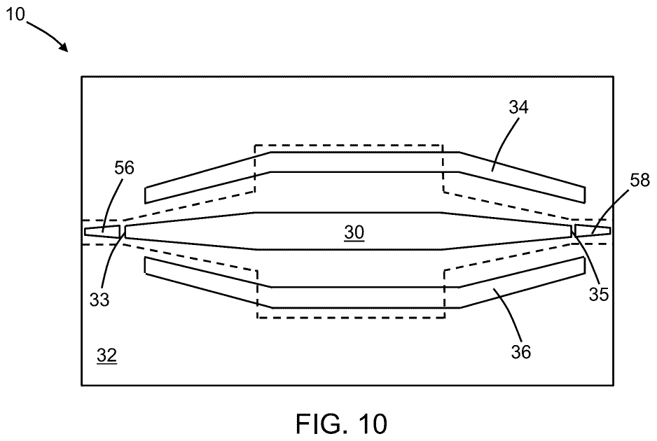

With reference to FIG. 10 and in accordance with alternative embodiments, a waveguide taper 56 may be formed over a portion of the waveguide core 12 adjacent to the end 33 of the quantum well structure 24 and a waveguide taper 58 may be formed over a portion of the waveguide core 12 adjacent to the end 35 of the quantum well structure 24. In an embodiment, the waveguide tapers 56, 58 may be comprised of a dielectric material, such as silicon nitride. The added waveguide tapers 56, 58 may further increase the modal overlap and coupling efficiency of propagating light with the quantum well structure 24, and the added waveguide tapers 56, 58 may also be effective to reduce back reflection.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”. “approximately”, and “substantially”, are not to be limited to the precise value or precise condition as specified. In embodiments, language of approximation may indicate a range of +/-10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or in “direct contact” with another feature if intervening features are absent. A feature may be “indirectly on” or in “indirect contact” with another feature if at least one intervening feature is present. Different features may “overlap” if a feature extends over, and covers a part of, another feature. A feature may “overlie” another feature if a feature is positioned “over” another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A structure for a hybrid plasmonic electro-absorption modulator, the structure comprising:
a first metal layer;
a second metal layer;
a waveguide core having a first portion; and
a multiple-layer structure on the first portion of the waveguide core, the multiple-layer structure comprising a first plurality of layers and a second plurality of layers that alternate with the first plurality of layers, the first plurality of layers comprising a first material, and the second plurality of layers comprising a second material, and the multiple-layer structure positioned in a lateral direction between the first metal layer and the second metal layer.

2. The structure of claim 1 wherein the first material is silicon-germanium, and the second material is silicon-germanium with a higher germanium content than the first material.

3. The structure of claim 1 wherein the first material is a first III-V compound semiconductor, and the second material is a second III-V compound semiconductor.

4. The structure of claim 1 wherein the first metal layer and the second metal layer comprise copper or aluminum.

5. The structure of claim 1 wherein the waveguide core includes a second portion and a third portion, the first portion of the waveguide core is positioned between the second portion and the third portion, and further comprising:
a first waveguide taper positioned over the second portion of the waveguide core; and
a second waveguide taper positioned over the third portion of the waveguide core.

6. The structure of claim 1 further comprising:
a semiconductor substrate; and
a dielectric layer on the semiconductor substrate,
wherein the dielectric layer is positioned between the semiconductor substrate and the waveguide core, the first metal layer, the second metal layer, and the multiple-layer structure.

7. The structure of claim 6 wherein the multiple-layer structure has a top surface, and further comprising:
a third metal layer overlapping with the top surface of the multiple-layer structure,
wherein the multiple-layer structure is positioned between the third metal layer and the dielectric layer.

8. The structure of claim 1 wherein the multiple-layer structure has a top surface, and further comprising:
a third metal layer overlapping with the top surface of the multiple-layer structure.

9. The structure of claim 8 wherein the third layer is in direct contact with the top surface of the multiple-layer structure, and further comprising:
a first interconnect coupled to the first metal layer;
a second interconnect coupled to the second metal layer; and
a third interconnect coupled to the third metal layer.

10. The structure of claim 1 further comprising:
a first interconnect coupled to the first metal layer;
a second interconnect coupled to the second metal layer; and
a third interconnect coupled to the multiple-layer structure.

11. The structure of claim 1 wherein the first metal layer has a sidewall, the multiple-layer structure has a first sidewall, and further comprising:
a first dielectric layer including a first portion positioned in the lateral direction between the sidewall of the first metal layer and the first sidewall of the multiple-layer structure, the first dielectric layer comprising a first dielectric material.

12. The structure of claim 11 wherein the second metal layer has a sidewall, the multiple-layer structure has a second sidewall opposite from the first sidewall, and the first dielectric layer includes a second portion positioned in the lateral direction between the sidewall of the second metal layer and the second sidewall of the multiple-layer structure.

13. The structure of claim 11 further comprising:
a second dielectric layer including a first portion positioned in the lateral direction between the sidewall of the first metal layer and the first sidewall of the multiple-layer structure, the second dielectric layer comprising a second dielectric material different from the first dielectric material.

14. The structure of claim 13 wherein the multiple-layer structure has a second sidewall opposite from the first sidewall, and the second dielectric layer includes a second portion positioned in the lateral direction between the sidewall of the second metal layer and the second sidewall of the multiple-layer structure.

15. The structure of claim 14 wherein the first dielectric layer includes a second portion positioned in the lateral direction between the sidewall of the second metal layer and the second sidewall of the multiple-layer structure.

16. The structure of claim 1 wherein the multiple-layer structure is a quantum well structure.

17. The structure of claim 1 wherein the waveguide core includes a second portion and a third portion, the first portion is positioned laterally between the second portion and the third portion, and the first metal layer includes a first section in direct contact with the second portion of the waveguide core.

18. The structure of claim 17 wherein the second metal layer includes a section in direct contact with the third portion of the waveguide core.

19. The structure of claim 17 wherein the first metal layer includes a second section and a third section, the first section is positioned between the second section and the third section, the second section is angled relative to the first section toward the multiple-layer structure, and the third section is angled relative to the first section toward the multiple-layer structure.

20. A method of forming a structure for a hybrid plasmonic electro-absorption modulator, the method comprising:
forming a first metal layer and a second metal layer;
forming a waveguide core; and
forming a multiple-layer structure on a portion of the waveguide core, wherein the multiple-layer structure comprises a first plurality of layers and a second plurality of layers that alternate with the first plurality of layers, the first plurality of layers comprise a first material, the second plurality of layers comprise a second material, and the multiple-layer structure is positioned in a lateral direction between the first metal layer and the second metal layer.
